(19) United States
(12) Patent Application Publication
(10) Pub. No.: US 2004/0017759 A1
(43) Pub. Date: Jan. 29, 2004

(54) Pickup device

(75) Inventors: Sakashi Ohtaki, Saitama (JP); Makoto Sato, Saitama (JP); Takehiro Matsuda, Saitama (JP)

Correspondence Address: SUGHRUE MION, PLLC, 2100 PENNSYLVANIA AVENUE, N.W., WASHINGTON, DC, 20037, US

(73) Assignee: PIONEER CORPORATION

(21) Appl. No.: 10/618,641

(22) Filed: Jul. 15, 2003

(30) Foreign Application Priority Data
Jul. 25, 2002 (JP) P. 2002-217170

(51) Int. Cl. G11B 7/135

(52) U.S. Cl. 369/112.09; 369/112.29

(57) ABSTRACT

In a pickup device 1, a rising mirror 11 is composed in such a manner that two mirrors (first and second mirrors) are respectively provided on both sides of a substantially parallel transparent substrate 11A. A dichroic mirror 11B (first mirror) formed on one face (surface) reflects a blue laser beam and transmits a red laser beam. A hologram mirror 11C (second mirror) provided on the other face (reverse face) reflects a red laser beam.

The present disclosure relates to the subject matter contained in Japanese Patent Application No. 2002-217170 filed on Jul. 25, 2002, which is incorporated herein by reference in its entirety.

### BACKGROUND OF THE INVENTION

1. Field of the Invention:

The present invention relates to a pickup device used for recording and playing back information on an information recording medium. More particularly, the invention relates to a pickup device used for recording and playing back information on an optical disk such as DVD (Digital Versatile Disk), optical disk of a large capacity provided in the next generation, and CD (Compact Disk).

2. Description of the Related Art:

Recently, a high-capacity optical disk of next generation having high capacity capable of recording a HDTV (High Resolution Digital Television) class images for two hours, has been explored. It is desired to provide a recording and playing back device compatible to record and play back the presently used DVD and the large capacity optical disk used in the next generation. However, concerning such pickup device, the same problems as those of the technique, in which the conventional DVD and CD are compatibly used, are caused.

For example, in a case where compatibility is realized by one objective lens, there is caused a problem of how to correct aberration of the objective lens with respect to a difference in the cover layer thickness of the information recording medium (optical disk), a difference in NA of the objective lens and a difference in the wave-length of light. Differences between various types of information recording media are shown on Table 1.

TABLE 1

| | High-capacity | | | | | |
|---|---|---|---|---|---|---|
| | optical disk of next | | | | | |
| | generation | | DVD | | CD | |
| Cover layer thickness | 0.1 | mm | 0.6 | mm | 1.2 | mm |
| NA of objective lens | 0.85 | | 0.6 | | 0.4 | |
| Wave-length used in | 405 | nm | 650 | nm | 780 | nm |
| recording and playing | | | | | | |
| back | | | | | | |

Compared with the realization of compatibility between DVD and CD, it is difficult to realize compatibility between a high-capacity optical disk of next generation and DVD because that NA of the objective lens is high and a ratio of the wave-length of light in the case of recording and playing back is high.

A technique of compatibility between a high-capacity optical disk of next generation and DVD is disclosed, for example, in the document of “HD/DVD Compatibility Using Hoe International Symposium on Optical Memory 2001, Pd-29, P304-305”.

According to the technique disclosed in the above document, compatibility is realized by combining an objective lens with a correction element to correct DVD aberration formed by a transmission type hologram, which is described as “HOE” in the above document.

In the above document, two types of holograms are proposed. One is a non-polarization hologram, and the other is a polarization hologram. In this connection, the non-polarization hologram has already been put into practical use in the field of technique of compatibility between DVD and CD. In addition, defects of non-polarization of light are corrected by use of the polarization hologram.

In the same manner as that of recording and playing back DVD, the objective lens is composed of a single-element lens. The reason using the single-element lens for an objective lens, is to ensure a WD (working distance). Normally, a two-element lens in which two lenses are combined with each other is used as the objective lens for the high-capacity optical disk of the next generation. However, in general, WD is short (not more than 0.24 mm) in use of the two-element lens, and therefore, the use of two-element lens is insufficient when DVD is recorded and played back.

Compared with a single-element lens used for DVD, NA of a single-element lens for the high-capacity optical disk of next generation is high. Therefore, in general, the radius of curvature becomes severe. Further, it is difficult to directly form the hologram on the surface of the objective lens.

According to the above document, the hologram is not formed on the objective lens but formed on one independent glass substrate, and this glass substrate is raised and arranged between the rising mirror and the objective lens.

Even when either the polarization hologram or the non-polarization hologram is used, use of exclusive parts other than the objective lens is necessary. Therefore, the number of parts increases, and the manufacturing cost becomes higher.

Also, by using the hologram, it is necessary to provide a sufficiently large space in the thickness direction. Further, since any type of hologram is driven integrally with the objective lens, the thickness of a pickup is increased. Therefore, it is difficult to reduce the thickness of a pickup device of Half-Height Standards.

Further, in the prior art described in the above document, the diffraction efficiency is low especially when in use of the non-polarization hologram. Accordingly, there is a possibility of occurrence of a loss of a quantity of transmission light and further there is a possibility of occurrence of stray light, which may deteriorate the signal-to-noise ratio. In the case of compatibility between DVD and CD, the ratio of wave-length is relatively close to 1 (the ratio of wave-length: 680 nm/780 nm=0.83). Therefore, the deterioration in diffraction efficiency is low that it is possible to put it into practical use. However, in the case of compatibility between a high-capacity optical disk of next generation and DVD, the difference in wave-length is large (the ratio of wave-length: 650 nm/405 nm=0.623) so that it is difficult to increase both of the diffraction efficiencies when the diffraction light of the same degree is used. According to the above document, in the case where the non-polarization hologram is used, although the theoretical values and the measurement values are different from each other, both values are merely about 80%.

The reason of above is that the depth of the hologram, by which the most appropriate diffraction efficiency is given, is decisively determined by the wave-length, and when it is used by two different wave-length, there is no other way but to use an intermediate depth so as to keep the balance. That is, the diffraction efficiency of the hologram sensitively changes with respect to the change in the wave-length of laser beams to be used, and therefore, the diffraction efficiency varies widely.

In order to improve the diffraction efficiency, a polarization hologram is proposed. And when using the polarization hologram, 0th-order diffraction can be used for a high-capacity optical disk of next generation, and 1st-order diffraction can be used for a DVD.

However, according to the above document, even though the theoretical values are improved, the actually measured values are considerably deteriorated when the non-polarization hologram is used. The deterioration of the actually measured values occurs due to an error caused when the hologram is manufactured, and is somewhat inevitable in using a transmission type hologram.

The values disclosed in the document are theoretical and calculated values obtained by calculation based on a configuration that the laser beam is transmitted through the hologram once, so that the transmission factor in the detection system of the laser beam returning thereto will be a square of the value of the diffraction efficiency described in the document.

When the polarization hologram is used, the beam incident on the optical disk becomes polarized. It is said that when polarized beam is incident on the optical disk, the beam is likely to be affected by double refraction and by profiles of pits on the optical disk, and that so-called playability deteriorates compared with circularly polarized light. For the above reasons, in the case of a pickup device used for DVD, a circularly polarized beam or an elliptically polarized beam is used in many cases.

In the above-described prior art, it is necessary to enhance the diffraction efficiencies of the wave-lengths of both the red laser beam and the blue laser beam in order to use the transmission type hologram. Therefore, it is necessary to design the hologram in which the diffraction efficiencies of both the wave-lengths are balanced. Accordingly, it is difficult to obtain a sufficiently high efficiency. It is also difficult to obtain sensitive, stable diffraction efficiency with respect to a difference in the depth of the hologram and a difference in the wave-length.

### SUMMARY OF THE INVENTION

The present invention has been accomplished in view of the above circumstances. It is an object of the invention to provide a pickup device that the number of necessary parts is small, can be manufactured at a low manufacturing cost, and the size thereof is small and thin.

In order to accomplish the above object, according to an aspect of the invention, there is provided a pickup device including: a first light source adopted to output a first laser beam; a second light source adopted to output a second laser beam having a band of longer wave-length than the first laser beam; a rising mirror adopted to reflect the first laser beam and the second laser beam; and an objective lens adopted to condense the first laser beam and the second laser beam reflected by the rising mirror onto an information recording medium, wherein the rising mirror comprises a first mirror and a second mirror respectively provided on both faces of a transparent substrate, wherein the first mirror reflects the first laser beam, and transmits the second laser beam, wherein the second mirror reflects the second laser beam, wherein the rising mirror is arranged in a manner that the first mirror faces the objective lens.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is an arrangement view showing an optical system of the pickup device of an embodiment of the invention;

FIGS. 2A and 2B are views showing a rising mirror, wherein FIG. 2A is a view showing a rising mirror in which a hologram mirror is used and FIG. 2B is a view showing a rising mirror in which an aspherical mirror is used;

FIG. 3A is a view showing operation of a hologram mirror of the embodiment when recording and playing back a high-capacity optical disk of next generation;

FIG. 3B is a view showing operation of a hologram mirror of the embodiment when recording and playing back DVD;

FIG. 4 is a pattern formed on the hologram mirror of the embodiment;

FIG. 5 shows a phase function of the hologram mirror of the embodiment;

FIG. 6 is a graph showing an off-axis characteristic of the hologram mirror of the embodiment;

FIG. 7 is a side view showing a three-dimensional model of the hologram pattern shown in FIG. 4, and is a view showing an example of a profile of a saw-toothed (blazed) shape;

FIG. 8 is a side view showing a three-dimensional model of the hologram pattern shown in FIG. 4, and is a view showing an example of a profile of a saw-toothed (blazed) shape having multiple steps;

FIG. 9 shows a formula of the aspherical mirror of the embodiment;

FIG. 10 is a graph showing an off-axis characteristic the an aspherical mirror of the embodiment;

FIG. 11 is a schematic illustration for explaining a center of the luminous flux of a red laser beam incident on a rising mirror and a center of the luminous flux of a blue laser beam of the embodiment.

FIG. 12 is an arrangement view of an optical system in which a two-wave-length laser for DVD and CD of a pickup device of the embodiment is arranged;

FIG. 13A is a perspective view showing an example of a biaxial actuator of the pickup device;

FIG. 13B is a perspective view showing an example of a movable section in which an objective lens and the rising mirror are composed separately from each other;

FIG. 14 is a perspective view showing an example in which a movable section, in which the objective lens and the rising mirror are integrated into one body, is composed so that tracking direction T and incident direction L can be parallel with each other; and

FIG. 15 is a perspective view showing an example in which a movable section, in which the objective lens and the rising mirror are integrated into one body, is composed so that tracking direction T and incident direction L can be perpendicular to each other.

### DETAILED DESCRIPTION OF THE PREFERRED EMBODIMENTS

Referring now to the accompanying drawings, an embodiment of the invention will be explained in detail as follows.

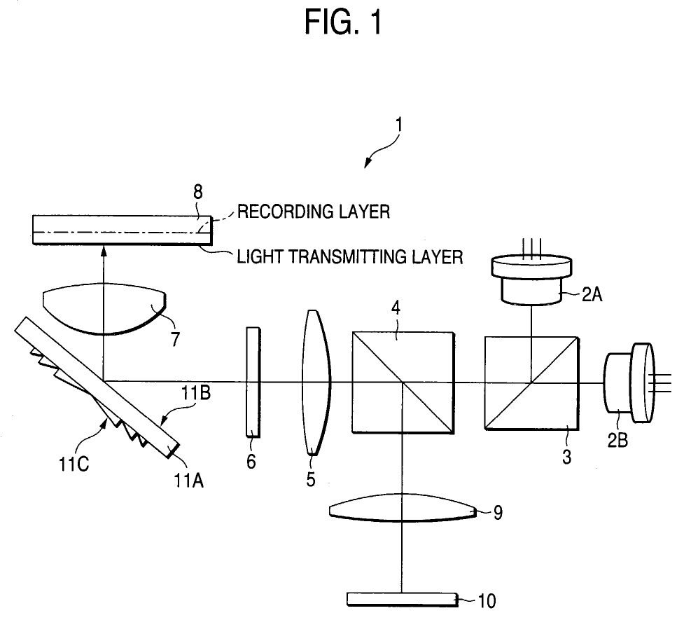

FIG. 1 is an arrangement view showing an optical system of a pickup device according to an embodiment of the invention.

As shown in FIG. 1, the pickup device 1 includes: a blue laser beam source 2A (beam source, the wave-length band of which is short); a red laser beam source 2B (beam source, the wave-length band of which is long); a color synthesizing prism 3; a beam splitter 4; a collimator lens 5; a ¼ wave plate 6; a rising mirror 11; an objective lens 7; a detecting leans 9; and a detector 10.

As shown in FIG. 1 in which an arrangement of the optical system is illustrated, the pickup device 1 records and plays back a information recording medium 8. The information recording medium 8 is an optical disk such as a high-capacity optical disk of next generation or DVD. The optical disks are provided with a laminated layer structure composed of a recording layer and light transmission layer. When the laser beam is incident onto the recording layer via a transparent light transmission layer, information is written on or read out from the recording layer.

The light source of the pickup device 1 of the embodiment includes two light sources, the wave-length bands of which are different from each other. One is a blue laser beam source 2A (beam source, the wave-length band of which is short) that outputs a first laser beam (blue laser beam) having a wave-length band of approximately 405 nm, and used for recording and playing back a high-capacity optical disk of next generation. And the other is a red laser beam source 2B (beam source, the wave-length band of which is long) that outputs a second laser beam (red laser beam) having a wave-length band of approximately 650 nm, and used for recording and playing back DVD.

The color synthesizing prism 3 is used for adjusting laser beams, which are incident on the prism 3 in different directions, into substantially same direction. The color synthesizing prism 3 has a characteristic that a red laser beam is transmitted and a blue laser beam is reflected. A laser beam, which is transmitted through the color synthesizing prism 3, is transmitted through the beam splitter 4 and made to be a parallel beam by the collimator lens 5. Thereafter, the laser beam is transmitted through the ¼ wave plate 6 and passes through the rising mirror 11 and is incident on the objective lens 7, so that a spot of the laser beam can be formed on the information recording medium 8.

The laser beam reflected on the information recording medium 8 is transmitted through the objective lens 7, rising mirror 11, ¼ wave plate 6, and collimator lens 5. Then, the laser beam is reflected on the beam splitter 4. After the laser beam has been reflected on the beam splitter 4, the laser beam is transmitted through the detecting lens 9 and incident on the detector 10. In the arrangement shown in FIG. 1, the example is shown in which only one detector 10 is used. However, it is possible to use two detectors, each used for the red laser beam and a detector used for the blue laser beam. It is also possible to use a module in which the beam source system (blue laser beam source 2A, red laser beam source 2B and color synthesizing prism 3) and the detecting system (beam splitter 4, detecting lens 9 and detector 10) are integrated into one body.

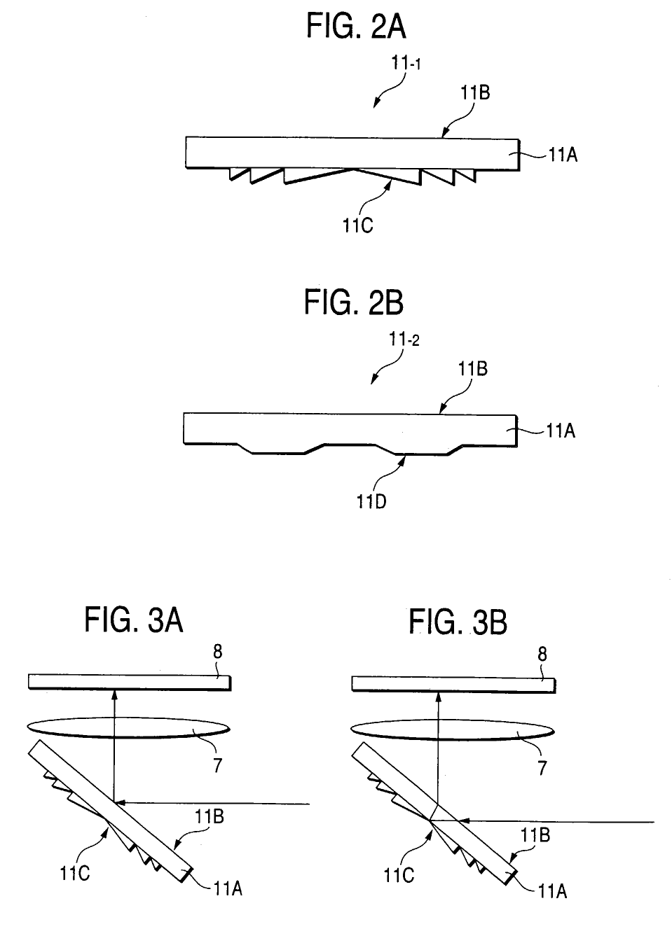

Next, the rising mirror 11 will be explained hereinafter. FIG. 2 is a view showing a model of the rising mirror 11. FIG. 2A shows a type (11-1) in which a hologram mirror is used, and FIG. 2B shows a type (11-2) in which an aspherical mirror is used.

As shown in FIGS. 2A and 2B, the rising mirror 11 is composed in such a manner that mirrors (first mirror and second mirror) are provided on both sides of the substantially parallel transparent substrate 11A. The first mirror (a dichroic mirror 11B) provided on one face (surface) of the substrate 11A reflects the blue laser beam and transmits therethrough the red laser beam. The second mirror (a hologram mirror 11C shown in FIG. 2A, or a aspherical mirror 11D shown in FIG. 2B) provided on the other side (opposite side) of the substrate 11A, reflects the red laser beam.

Next, operation of the above rising mirror 11 when in recording and playing back will be explained hereinafter in an example in which the second mirror is composed of the hologram mirror 11C. FIG. 3A is a view showing operation of the hologram mirror in the case of recording and playing back a high-capacity optical disk of next generation, and FIG. 3B is a view showing operation of the hologram mirror in the case of recording and playing back DVD.

As shown in FIG. 3A, in the case of recording and playing back the high-capacity optical disk of next generation, the blue laser beam, the wave-length band of which is approximately 405 nm, is used. Therefore, the laser beam reflects on the dichroic mirror 11B provided on the surface and is incident on the objective lens 7. The objective lens 7 is designed so that it can be appropriately used for a high-capacity optical disk of next generation. Therefore, an excellent laser beam spot can be formed on the recording face of the information recording medium 8.

As shown in FIG. 3B, in the case of recording and playing back DVD, the red laser beam, the wave-length band of which is approximately 650 nm, is used. Therefore, the laser beam is transmitted through the dichroic mirror 11B on the surface and is incident on the hologram mirror 11C on the reverse face. This incident laser beam is diffracted by the hologram. Since there is provided a reflecting layer on which the red laser beam is reflected, this incident laser beam is simultaneously reflected on the reflecting layer and returned onto the surface again. Since the surface is composed of the dichroic mirror 11B, the laser beam is transmitted through the surface. Thereafter, the laser beam is incident on the objective lens 7, so that an excellent spot of the laser beam can be formed on the recording face of the information recording medium 8.

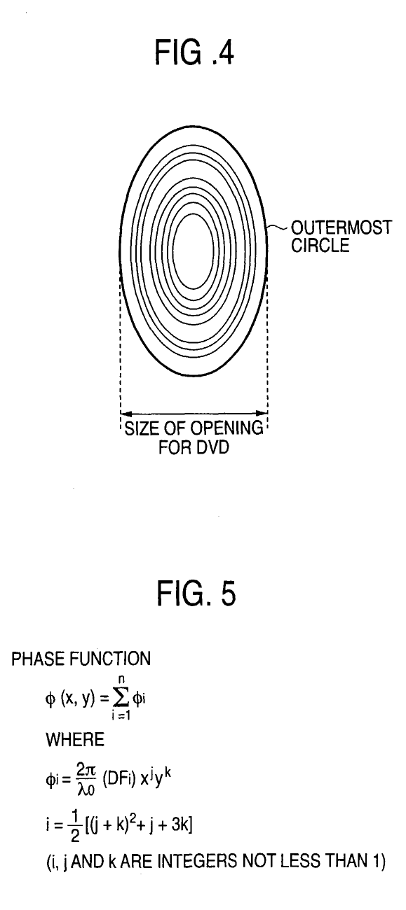

Concerning the hologram of the hologram mirror 11C, a concentric pattern such shown in FIG. 4 is formed. This pattern is previously designed so that a diffracting function can be provided by which aberration (spherical aberration or chromatic aberration), which is caused by the objective lens 7 in the case of recording and playing back DVD, can be corrected. Therefore, even in the case of DVD, it is possible to form an excellent spot of the laser beam on the recording and playing back face with respect to DVD.

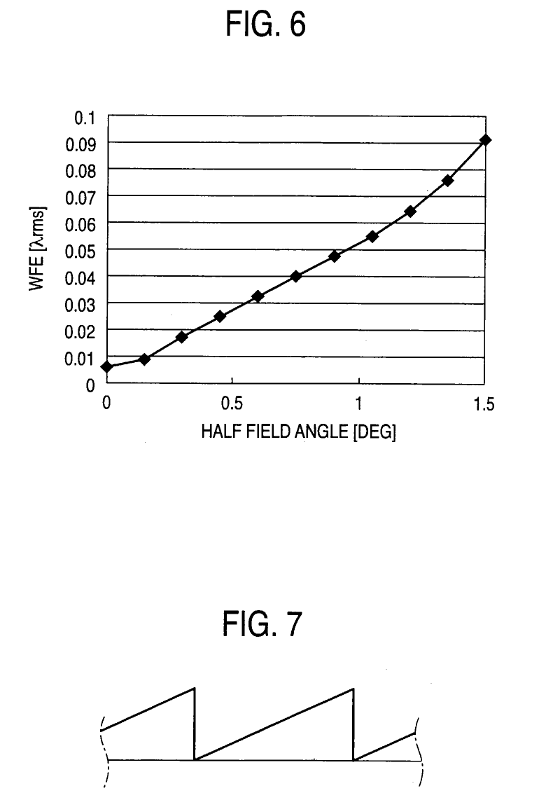

The phase function of this hologram pattern is shown in FIG. 5, and values of coefficient DFi in a design example are shown in Table 2. The off-axis characteristic (characteristic off the optical axis) of the thus obtained hologram is shown in FIG. 6. In FIG. 6, the ordinate (WFE) represents a value obtained when aberration such as spherical aberration or chromatic aberration is synthesized and normalized. The abscissa (Half Field Angle) represents an incident angle of the optical axis. In the phase function shown in FIG. 5, λ₀ is a constant (designed wave-length), and λ₀=650 [nm].

TABLE 2
Values of coefficient DFi

| | | | | | | | |
|---|---|---|---|---|---|---|---|
| | | DE1 | 0 | DF2 | 0 | DF3 | 0.008041 |
| DF4 | 0 | DF5 | 0.003988 | DF6 | 0 | DF7 | 0 |
| DF8 | 0 | DF9 | −9.85E−06 | DE10 | −0.00178 | DF11 | 0 |
| DF12 | −0.00169 | DF13 | −8.25E−12 | DF14 | −0.0004 | DF15 | 0 |
| DF16 | 0 | DF17 | 0 | DF18 | 1.76E−05 | DF19 | 0 |
| DF20 | 5.51E−06 | DF21 | −0.000611 | DF22 | 0 | DF23 | −0.001056 |
| DF24 | 0 | DF25 | −0.000612 | DF26 | 0 | DF27 | −0.000112 |
| DF28 | 0 | DF29 | 0 | DF30 | 0 | DF31 | 0 |
| DF32 | 0 | DF33 | 0 | DF34 | 0 | DF35 | 0 |
| DF36 | 4.73E−06 | DF37 | 0 | DF38 | 0.000134 | DF39 | 0 |
| DF40 | 0.000224 | DF41 | 0 | DF42 | 0.000115 | DF43 | 0 |
| DF44 | 1.79E−05 | DF45 | 0 | DF46 | 0 | DF47 | 0 |
| DF48 | 0 | DF49 | 0 | DF50 | 0 | DF51 | 0 |
| DF52 | 0 | DF53 | 0 | DF54 | 0 | DF55 | −2.84E−05 |
| DF56 | 0 | DF57 | −0.00011 | DF58 | 0 | DF59 | −0.000164 |
| DF60 | 0 | DF61 | −0.000111 | DF62 | 0 | DF63 | −3.44E−05 |
| DF64 | 0 | DF65 | −3.88E−06 | | | | |

The hologram mirror 11C is made of at least one of glass and plastics. For example, the hologram face is made of glass or plastics being formed by means of photolithography to which an etching process using a photo-mask is applied. Alternatively, the hologram face is made of glass or plastic being formed by means of injection molding. Alternatively, it is possible to form the hologram with plastics such as 2P (photopolymer) on a glass substrate.

The dichroic mirror 11B provided on the surface is usually composed of an optical multilayer film on which dielectric thin films are laminated by a coating technique such as vapor deposition or spattering.

On the other hand, the hologram mirror 11C on the reverse face is formed by coating the hologram pattern with an optical multilayer film or metallic reflecting film made of aluminum or silver.

The hologram pattern shown in FIG. 4 is limited within an opening size suitable for playing back DVD. Outside of the opening of the hologram pattern, a hologram pattern distinguished from the inside of the opening is formed so that the hologram pattern can not contribute to the condensation of light conducted by the objective lens, which will be specifically explained as follows.

The opening size represents an effective diameter of the objective lens 7, and the following equation is established.

(Effective diameter of objective lens)=(NA of objective lens)×(Focal length of objective lens)×2

In this embodiment, compatibility of DVD with a high-capacity optical disk of next generation is realized by the rising mirror 11. Therefore, the focal length is the same and NA is different. In the case of DVD, NA is low. Accordingly, it is necessary to limit the effective diameter (opening size).

For example, the respective effective diameters (opening sizes) are as below.

The opening size of DVD is 2.1 (=0.60×1.77 (mm)×2).

The opening size of a high-capacity optical disk of next generation is 3.0 (=0.85×1.77 (mm)×2).

Therefore, it is necessary to add a function of limiting an opening into the optical system. In this embodiment, the opening is limited on the hologram mirror 11c on the rising mirror 11. In this case, the hologram pattern becomes an elliptical profile (shown in FIG. 4) which is obtained when a circle is projected by an angle of 45°. In FIG. 4, the outermost circle (shown by a bold line), which is obtained when the hologram pattern is projected onto an inclined plane of 45°, becomes the opening size. A hologram pattern (not shown) to be distinguished from the inside of the opening is formed outside of the outermost circle.

Concerning the hologram pattern distinguished from the inside of the opening, for example, outside of the outermost circle, there is provided a dull face to diffuse light, an inclined face, a curved face and a diffraction pattern to diffract light in a different direction having no reflecting face.

When the hologram pattern shown in FIG. 4 is viewed three-dimensionally, it has a saw-toothed (blazed) shape or a pseudo saw-toothed shape. In this case, the concentric circle shown in FIG. 4 corresponds to a vertex of the saw-tooth. The reason why the saw-toothed shape is formed is that in order to enhance the diffraction efficiency of the hologram, it is effective to form the hologram into the saw-tooth-shape. In the embodiment, it is preferable to form the hologram into the saw-toothed shape shown in FIG. 7. When the shape is formed, the theoretical diffraction efficiency becomes 100%.

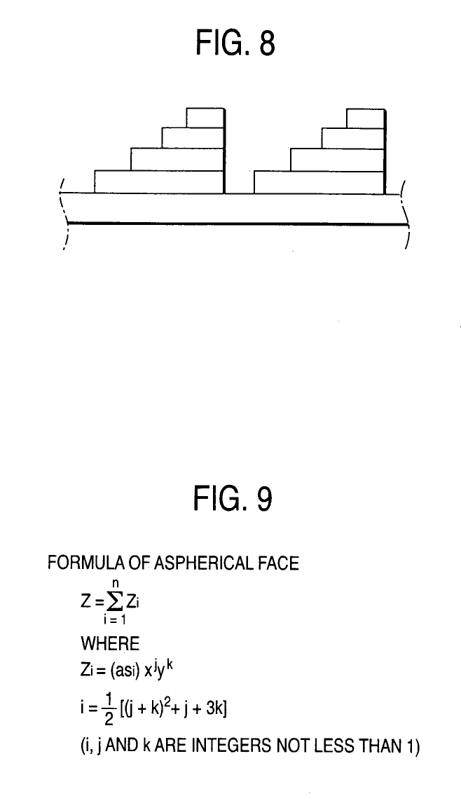

Alternatively, the pseudo multistage saw-toothed shape shown in FIG. 8 may be formed. This shape can be formed, for example, when a plurality of photo-masks are used and the etching process is repeatedly conducted. The theoretical value of the diffraction efficiency is 95% in the case of three photo-masks (eight steps).

The above explanations are made into a case in which the hologram mirror is used. However, the same effect can be provided even in the case in which the aspherical mirror 11D shown in FIG. 2B having an aspherical face and reflecting a red laser beam is used.

Even in the case of using the aspherical mirror 11D, in the same manner as that of the hologram mirror 11C, the surface of the rising mirror 11 is provided with a dichroic mirror on which a blue laser beam is reflected and through which a red laser beam is transmitted. The arrangement of the pickup device 1 is the same as that shown in FIG. 1. An aspherical face of the aspherical mirror 11D has a function of correcting aberration caused by the objective lens 7 in the case of recording and playing back DVD.

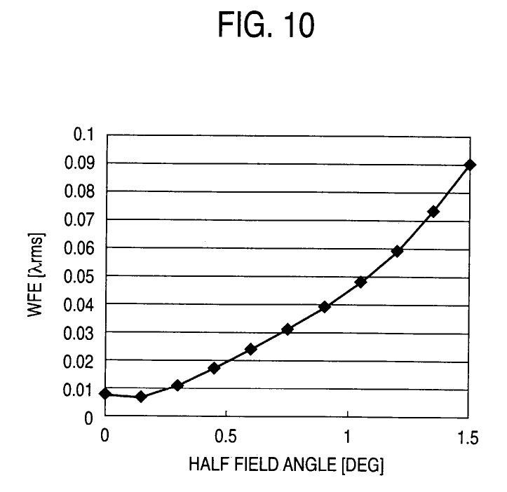

Values of coefficient ASi in an exemplary case of designing the aspherical mirror are shown on Table 3. The off-axis characteristic is shown in FIG. 10.

The formula of this aspherical face is shown in FIG. 9, and values of coefficient ASi in an exemplary case of designing this aspherical mirror are shown on Table 3. The off-axis characteristic (characteristic off the optical axis) of the thus obtained aspherical mirror is shown in FIG. 10. In FIG. 10, the ordinate (WFE) represents a value obtained when aberration such as spherical aberration or chromatic aberration is synthesized and normalized. The abscissa (Half Field Angle) represents an incident angle of the optical axis.

TABLE 3
Values of coefficient ASi

| | | | | | | | |
|---|---|---|---|---|---|---|---|
| | | AS1 | 0 | AS2 | 0 | AS3 | −0.001006 |
| AS4 | 0 | AS5 | −0.000497 | AS6 | 0 | AS7 | 0 |
| AS8 | 0 | AS9 | −1.32E−05 | AS10 | 0.000574 | AS11 | 0 |
| AS12 | 0.000553 | AS13 | −2.26E−10 | AS14 | 0.000135 | AS15 | 0 |
| AS16 | 0 | AS17 | 0 | AS18 | 1.88E−05 | AS19 | 0 |
| AS20 | 7.1E−06 | AS21 | 0.000291 | AS22 | 0 | AS23 | 0.000451 |
| AS24 | 0 | AS25 | 0.000229 | AS26 | 0 | AS27 | 3.88E−05 |

The substrate of the above aspherical mirror is made by means of injecting plastics or press forming. Alternatively, the substrate of the above aspherical mirror may be made in such a manner that an aspherical face is composed of plastic material such as 2P on a parallel plane substrate made of glass.

In this connection, in the embodiment, it is necessary for the ¼ wave plate 6 to act on both the wave-length band of the red laser beam and the wave-length band of the blue laser beam.

In order to satisfy the above condition, the phase difference Δnd (which nearly equals to the value of (2n−1)×λ/4) maybe satisfied in the above two wave-length bands (Δn: difference in refractive index, d: thickness of wave plate, n: integer, λ: wave-length).

For example, when λ=405 nm and n=3, Δnd=506 nm. When λ=650 nm and n=2.06, the value of n substantially satisfies the condition n=2.

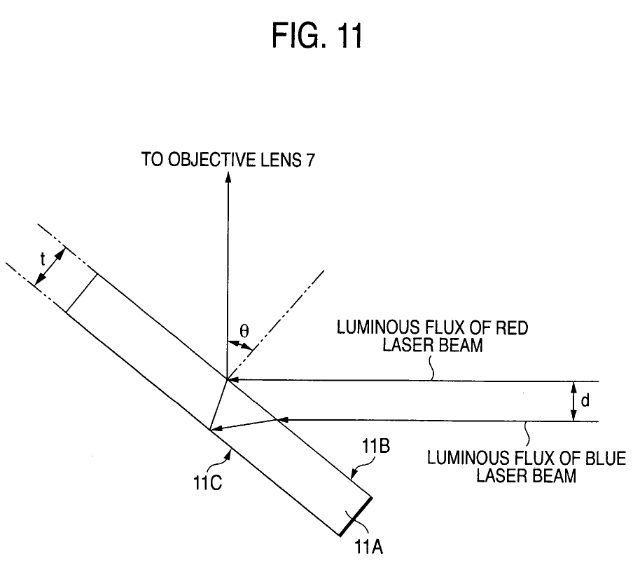

As shown in FIG. 11, the center of the luminous flux of the red laser beam and that of blue laser beam are shifted from each other by an appropriate distance. In order to make the luminous flux of the red laser beam, which is incident on the objective lens 7 after reflection on the rising mirror 11, coincide with the luminous flux of the blue laser beam which is incident on the objective lens after reflection on the rising mirror 11, it is necessary to previously shift the center of the luminous flux of the red laser beam and the center of the luminous flux of the blue laser beam incident on the rising mirror 11 from each other.

The blue laser beam reflects on the dichroic mirror 11B provided on the surface of the rising mirror, and the red laser beam reflects on the hologram mirror 11C on the reverse face of the rising mirror. Therefore, the luminous flux of the blue laser beam is shifted from the luminous flux of the red laser beam. When the angle q of the rising mirror is 45°, distance d of the shift of the luminous flux is expressed by d=t/n (which can be modified into expression d=(2t×sin²θ)/n, wherein the angel is θ), wherein the thickness of the mirror 11 is t, and the refractive index is n. For example, in the case where t=1.2 mm and n=1.6, it is necessary to shift the luminous flux by the distance d=0.75 mm. Although it is unnecessary for the luminous flux of the blue laser beam and that of the red laser beam to precisely coincide with each other, in order to prevent a distribution of a quantity of light from being affected, it is necessary to shift the center of the luminous flux in a predetermined range.

A direction of shifting the luminous flux is the vertical direction in FIG. 11. The luminous flux is shifted in such a manner that the laser beam (blue laser beam), which is used for a high-capacity optical disk of next generation, comes upward (on the objective lens 7 side). An allowance of the distance of shifting the luminous flux is approximately 0.5 mm. When the allowance of the distance of shifting the luminous flux is set at a value close to 0.5 mm, the distribution of the quantity of light is seldom affected.

As described above, in the embodiment, compatibility of the high-capacity optical disk of next generation with DVD is realized. However, it is also possible to realize compatibility of the high-capacity optical disk of next generation with CD. In this case, the hologram mirror pattern on the reverse face may be a hologram pattern appropriate to ensure compatibility of DVD with CD.

Due to the above structure, in addition to compatibility of the high-capacity optical disk of next generation with DVD, the pickup device becomes possible to record and play back CD-R. Therefore, a laser beam source (infrared ray source) close to 780 nm appropriate to record and play back CD-R is added to the device.

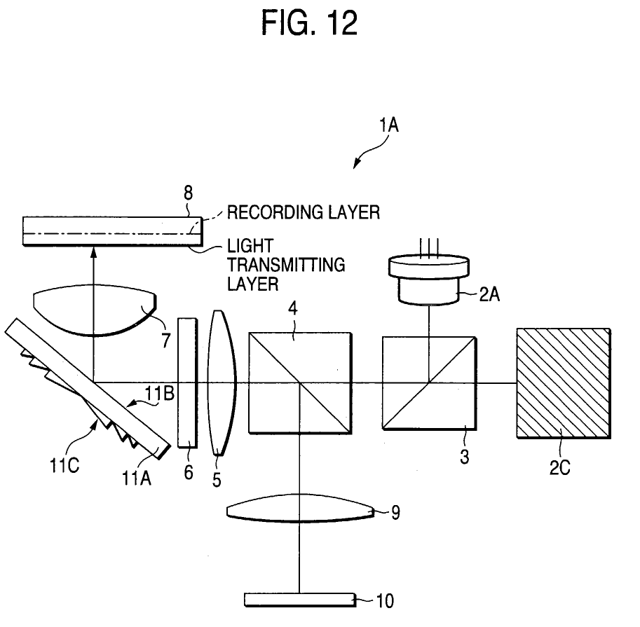

FIG. 12 is a view showing a pickup device 1A in which a so-called two wave-length laser 2C is used. The two wave-length laser 2C is a laser beam source for DVD and a laser beam source for CD are accommodated in one package so as to make the pickup device compact. In this case, the hologram pattern may be a pattern suitable for recording and playing back both DVD and CD-R.

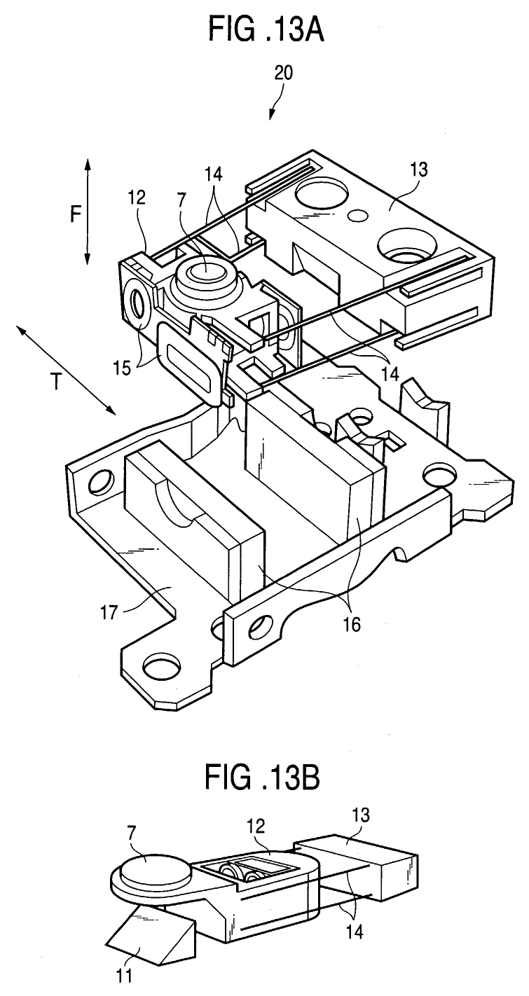

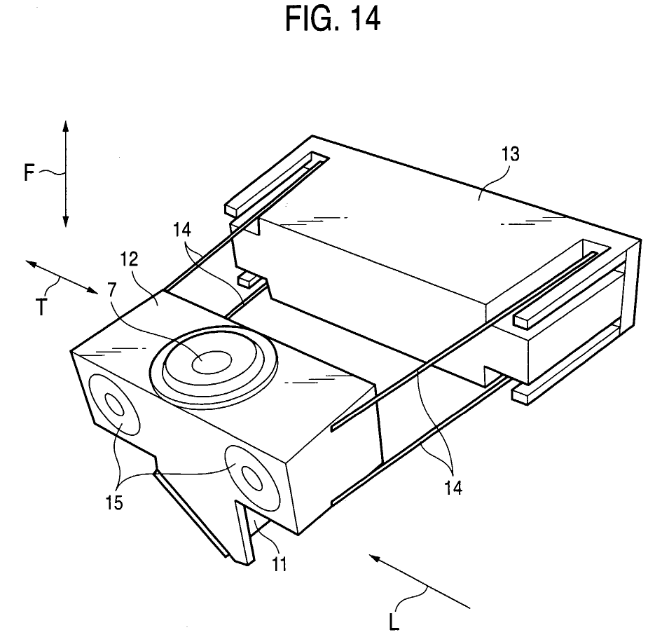

Next, explanations will be made into a biaxial actuator of the pickup device of the present embodiment. FIG. 13A is a perspective view showing an example of the biaxial actuator of the pickup device, and FIG. 13B is a perspective view showing an example of the movable section in which the objective lens and the rising mirror are composed separately from each other.

In FIG. 13A, the movable section 12 of the biaxial actuator 20 holds the objective lens and is moved along the two axes of focus direction F and tracking direction T. On the side of the movable section 12, there is provided a coil 15. The movable section 12 is connected with the stationary section via the support spring 14. When this movable section 12 is arranged between the magnets 16, 16, the movable section 12 can be moved in focus direction F and tracking direction T by the coils 15, 15.

As shown in FIG. 13B, in the common pickup device, the rising mirror 11 is not fixed to the movable section 12. In order to make the thickness of the pickup device thin, the objective lens 7 is arranged in an upper portion of the movable section 12, and a lower portion is greatly cut out. In this structure, it is difficult to enhance rigidity. Accordingly, unnecessary resonance tends to occur. When the thickness of the structure is increased so as to avoid the occurrence of unnecessary resonance, the weight is increased, and it becomes difficult to obtain a predetermined sensitivity.

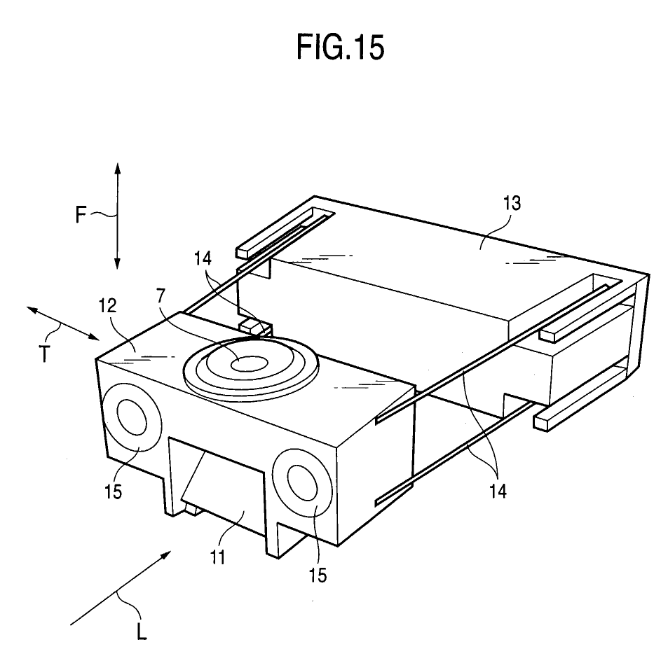

On the other hand, in the present embodiment, as shown in FIGS. 14 and 15, the objective lens 7 and the rising mirror 11 are integrated into one body with the movable section 12. When the objective lens 7 and the rising mirror 11 are integrated into one body with the movable section 12 as shown in FIGS. 14 and 15, even if the thickness of the structure is decreased, it is possible to maintain high rigidity, which is capable of providing a preferable characteristic for the actuator.

In the structure in which the objective lens 7 and the rising mirror 11 are not integrated into one body, when the movable section is moved upward and downward in focus direction F, it is necessary to provide a space to avoid collision of the objective lens 7 with the rising mirror 11. However, in the structure in which the objective lens 7 and the rising mirror 11 are integrated into one body, it becomes unnecessary to provide the above space. Therefore, thickness of the device can be effectively reduced.

Next, explanations will be made into a relation between tracking direction T and direction L of the laser beam incident on the rising mirror 11. FIG. 14 shows an example in which the movable section 12, in which the objective lens 7 and the rising mirror 11 are integrated into one body, is composed so that tracking direction T and incident direction L can be parallel with each other. FIG. 15 shows an example in which the movable section 12 is composed so that tracking direction T and incident direction L can be perpendicular to each other.

It is preferable that a position of the luminous flux, which is incident on the rising mirror 11 in incident direction L, is not changed when the movable section 12 is moved in tracking direction T. Therefore, it is preferable that tracking direction T is substantially parallel with incident direction L of the laser beam incident on the rising mirror 11. Accordingly, it is more preferable to adopt the structure shown in FIG. 14.

As explained above, in the embodiment, the rising mirror 11 is used as a component to obtain compatibility of optical disks (information recording media) of different standards. Therefore, the number of parts is the same as that of a pickup device in which only an optical disk of a single standard is used.

In the conventional pickup device in which optical disks of a plurality of standards are used, there are provided parts necessary for obtaining compatibility. On the other hand, in the pickup device of the embodiment, the number of necessary parts is small, which can reduce the manufacturing cost.

In the conventional pickup device in which optical disks of a plurality of standards are used, there are provided parts necessary for obtaining compatibility in a lower portion of the objective lens. Therefore, the conventional pickup device is not suitable for reducing the thickness. However, in the embodiment, such parts are not provided. Therefore, the pickup device of the present embodiment is suitable for reducing the thickness.

Further, in the case where the objective lens 7 and the rising mirror 11 are integrated into one body with the movable section 12 of the biaxial actuator, thickness of the pickup device can be more reduced.

In the embodiment, the function is separated in such a manner that the blue laser beam is reflected on the surface and the red laser beam is reflected on the reverse face. Therefore, the diffraction efficiency can be enhanced. Although reflection on the surface depends on the characteristic of the dichroic mirror, the diffraction efficiency can be easily enhanced to a value close to 100%.

Accordingly, the efficiency of the pickup of the invention in the case of a high-capacity optical disk of next generation is as high as that of the pickup exclusively used for the high-capacity optical disk of next generation. On the other hand, even in the case of DVD, the hologram on the reverse face may be designed so that it can be exclusively used for a red laser beam. Therefore, dependence upon the wave-length and deterioration of the diffraction efficiency caused by errors in the manufacturing process can be suppressed. Accordingly, it is possible to expect a high efficiency.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A pickup device comprising:
a first light source adopted to output a first laser beam;
a second light source adopted to output a second laser beam having a band of longer wave-length than the first laser beam;
a rising mirror adopted to reflect the first laser beam and the second laser beam; and
an objective lens adopted to condense the first laser beam and the second laser beam reflected by the rising mirror onto an information recording medium,
wherein the rising mirror comprises a first mirror and a second mirror respectively provided on both faces of a transparent substrate,
wherein the first mirror reflects the first laser beam, and transmits the second laser beam,
wherein the second mirror reflects the second laser beam,
wherein the rising mirror is arranged in a manner that the first mirror faces the objective lens.

2. The pickup device as claimed in claim 1, wherein the first light source outputs the first laser beam having a wave-length band of approximately 405 nm, wherein the second light source outputs the second laser beam having a wave-length band of approximately 650 nm.

3. The pickup device as claimed in claim 1, wherein the first light source outputs the first laser beam having a wave-length band of approximately 650 nm, wherein the second light source outputs the second laser beam having a wave-length band of approximately 780 nm.

4. The pickup device as claimed in claim 1, wherein a center of a luminous flux of the first laser beam incident to the rising mirror is shifted in direction toward the objective lens from a center of a luminous flux of the second laser beam incident to the rising mirror.

5. The pickup device as claimed in claim 1, wherein the first mirror comprises a dichroic mirror.

6. The pickup device as claimed in claim 1, wherein the second mirror comprises a hologram mirror having a hologram pattern formed thereto.

7. The pickup device as claimed in claim 6, wherein the hologram pattern is formed in a pattern having a diffracting function adapted to correct aberration that is caused by the objective lens in the process of recording and playing back the information recording medium by use of the first laser beam.

8. The pickup device as claimed in claim 7, wherein the hologram pattern is formed in a pattern having a diffracting function adapted to correct aberration that is caused by the objective lens in the process of recording and playing back DVD.

9. The pickup device as claimed in claim 6, wherein the hologram mirror is made of at least one of glass and plastic.

10. The pickup device as claimed in claim 6, wherein the hologram pattern of the hologram mirror is limited within an opening size appropriate for playing back the information recording medium by use of the first laser beam, and
wherein in a region of the hologram mirror except for a region in which the hologram pattern is formed, a hologram pattern is formed in a pattern not contributing to the condensation of the laser beam by the objective lens.

11. The pickup device as claimed in claim 10, wherein the hologram pattern of the hologram mirror is limited within an opening size appropriate for playing back DVD.

12. The pickup device as claimed in claim 6, wherein the hologram pattern has a profile of saw-toothed shape.

13. The pickup device as claimed in claim 1, wherein the second mirror comprises an aspherical mirror having an aspherical profile.

14. The pickup device as claimed in claim 13, wherein the aspherical mirror is formed into an aspherical profile by which aberration caused by the objective lens is corrected when information is recorded on and played back from the information recording medium.

15. The pickup device as claimed in claim 13, wherein the aspherical mirror is made of at least one of glass and plastic.

16. The pickup device as claimed in claim 1, wherein the objective lens and the rising mirror are arranged being integrated into one body with a movable section of a biaxial actuator.

17. The pickup device as claimed in claim 16, wherein a tracking direction of the biaxial actuator and a direction of the luminous flux of the first and the second laser beam incident on the rising mirror substantially coincide with each other.
